(19) United States
(12) Patent Application Publication
(10) Pub. No.: US 2018/0044054 A1
(43) Pub. Date: Feb. 15, 2018

(54) CONTAINER FOR ENCASEMENT

(71) Applicant: GROUNDSTAR CO., LTD., Miyazaki (JP)

(72) Inventor: Soichiro SAITO, Miyazaki-city (JP)

(73) Assignee: Groundstar Co., Ltd., Miyazaki (JP)

(21) Appl. No.: 15/553,280

(22) PCT Filed: Nov. 27, 2015
(86) PCT No.: PCT/JP2015/083497

§ 371 Date: Aug. 24, 2017

(30) Foreign Application Priority Data
Apr. 17, 2015 (JP) 2015-085436

(51) Int. Cl. B65D 5/52; B65D 5/50

(52) U.S. Cl. CPC B65D 5/528; B65D 5/5002; F21V 35/00

(57) ABSTRACT

The present invention is to provide a container for encasement, specifically a container for encasing a bottle that has an internal container for encasement and an external container for encasement, so that the vertically long container can easily let a bottle in or out, or in and out in the standing position. The container for encasement includes: an internal container for encasement; and an external container for encasement, in which the internal container for encasement includes an opening and closing case that is capable to open and close to let an object in or out, or in and out and limits the open range of the opening and closing case when the opening and closing case opens.

### TECHNICAL FIELD

The present invention relates to a container for encasement, specifically, a container for encasing a bottle.

### BACKGROUND ART

Some containers for encasing a bottle of drinking water, sake, wine, whisky, distilled spirit, juice, or the like are unfolded in a flat shape and stacked when not used; and individually folded by a predetermined way when used. Some of these containers for encasement have a special shape to conform the size and the shape of each bottle. Furthermore, some containers for encasement used for a gift are decorated on the outer face. The material of the containers for encasement is generally a paper such as a coated board or a cardboard (refer to Patent Documents 1 and 2).

The containers for encasement that have a simple structure are vulnerable to impact, for example, drop impact. Even if resisting to impact, the containers for encasement are just used for encasing a bottle. For example, containers for encasing a bottle of sake or wine are disposed or used for accessory cases when or after sake or wine is drunk. Some of the containers for encasement may be kept together with the bottle in memory.

By the way, generally, fantastic and romantic worlds or the like are often produced variously by darkening the inside and lighting candles in a restaurant or the like to enhance the mood and to make meals more delicious. This atmosphere is created by using the flame of a candle in candle sleeves and candle holders (refer to Patent Document 3). Such creation of atmosphere is also compounded in various eating places other than restaurants, wedding receptions, parties, and general households.

In the general household, candle sleeves and candle holders should usually be purchased separately from an alcohol drink such as sake or wine. However, the sales locations for alcohol drinks and candle sleeves may be away from each other at a considerable distance, even in a same store, for example, a large-scale store. In this case, it is inconvenient to purchase both of them due to the long distance. Therefore, the inventors have invented a container for encasement in which a part of the container for encasing a bottle is formed as a candle sleeve to alleviate the inconvenience to purchase a candle sleeve separately from a bottle when drinking beverage, especially alcohol drink in a bottle while enjoying the effect of the atmosphere created by the candle sleeve. Therefore, the container for encasement can notably exert the effect of creation of the atmosphere when the part of the container is used as a candle sleeve (refer to Patent Document 4).

The container for encasement described in Patent Document 4 is vertically long, which is laid to let in and out a laid bottle. The container has a widely-formed opening to let in and out a bottle and a bottle base locking part to prevent a bottle from rolling, so that a bottle can be safely and easily inserted and withdrawn from the container.

On the other hand, assumingly, the vertically long “paper box for encasement” described in FIGS. 1 to 8 of Patent Document 1 lets in and out a bottle by using the “lid 19” in the standing position. Furthermore assumingly, the vertically long “container for a bottle” described in Patent Document 2 also lets in and out a bottle by using the “mouth of the container for a bottle 1” in the standing position. However, these containers inconveniently let in and out a bottle because the openings of the “lid 19” and the “mouth of the container for a bottle 1” that are formed in the upper part of the vertically long container are small.

### CITATION LIST

### Patent Literature

Patent Document 1: JP 2007-284067 A

Patent Document 2: JP 3058154 Y

Patent Document 3: JP 3066697 Y

Patent Document 4: JP 3196409 Y

### SUMMARY OF INVENTION

An objective of the present invention is to provide a container for encasement, specifically a container for encasing a bottle that has an internal container for encasement and an external container for encasement, so that the vertically long container can easily let a bottle in or out, or in and out in the standing position.

According to the first aspect of the present invention, the container for encasement of the present invention includes:
an internal container for encasement; and
an external container for encasement, in which
the internal container for encasement includes:
   an opening and closing case that is capable to open and close to let an object in or out, or in and out; and
   a limitation part that limits the open range of the opening and closing case when the opening and closing case opens.

According to the second aspect of the present invention, in the container for encasement of the present invention, the external container for encasement is formed as a candle sleeve.

According to the third aspect of the present invention, in the container for encasement of the present invention, the limitation part is provided in the bottom of the internal container for encasement.

According to the fourth aspect of the present invention, in the container for encasement of the present invention, the limitation part includes a flap that has an inclining side and limits the open range of the opening and closing case by attaching the flap to the opening and closing case and engaging the inclining side with the opening and closing case.

According to the fifth aspect of the present invention, in the container for encasement of the present invention, the open range of the opening and closing case is an open angle of the opening and closing case.

According to the sixth aspect of the present invention, in the container for encasement of the present invention, the open range of the opening and closing case is an amount of rotation of the opening and closing case.

According to the seventh aspect of the present invention, in the container for encasement of the present invention, the open range of the opening and closing case is a position where the opening and closing case opens.

According to the eighth aspect of the present invention, in the container for encasement of the present invention, the open range of the opening and closing case is a distance where the opening and closing case opens.

According to the ninth aspect of the present invention, in the container for encasement of the present invention, the opening and closing case includes a pair of a first and a second opening and closing cases that are placed to face each other.

According to the tenth aspect of the present invention, in the container for encasement of the present invention, the upper part of the opening and closing case includes a top protection part that protects the top of the encased object.

According to the eleventh aspect of the present invention, in the container for encasement of the present invention, the internal container for encasement further includes a lid on the top and a base on the bottom, the lid locks the opening and closing case to keep the opening and closing case closed, and the base is fixed in the bottom of the internal container for encasement to protect the bottom of the object.

According to the present invention, the container for encasement provided with an opening and closing case is formed vertically long to prevent the opening and closing case from opening more than a predetermined range when the opening and closing case is opened to let a bottle in or out, or in and out in the standing position. Therefore, the container for encasement can easily let a bottle in or out, or in and out in the standing position.

Furthermore, according to the present invention, a part of the container for encasement is formed as a candle sleeve. Therefore, the container for encasement can notably exert the effect of creation of the atmosphere when the part of the container for encasement is used as a candle sleeve

### BRIEF DESCRIPTION OF DRAWINGS

FIG. 1 shows an expansion plan of the left opening and closing case of an internal container for encasement according to one embodiment of the present invention.

FIG. 2 shows an expansion plan of the right opening and closing case of an internal container for encasement according to one embodiment of the present invention.

FIG. 3 shows an expansion plan of the bottom of an internal container for encasement according to one embodiment of the present invention.

FIG. 4 shows an expansion plan of the lid of an internal container for encasement according to one embodiment of the present invention.

FIG. 5 shows an expansion plan of the base of an internal container for encasement according to one embodiment of the present invention.

FIG. 6 shows an expansion plan of the base support of an internal container for encasement according to one embodiment of the present invention.

FIG. 7 shows an expansion plan of an external container for encasement according to one embodiment of the present invention.

FIG. 8 shows a perspective view of an assembled left opening and closing case according to one embodiment of the present invention.

FIG. 9 shows a perspective view of an assembled bottom according to one embodiment of the present invention.

FIG. 10 shows a perspective view in which the bottom is attached to the left opening and closing case, according to one embodiment of the present invention.

FIG. 11 shows a perspective view of an assembled internal container for encasement according to one embodiment of the present invention.

FIG. 12 shows a perspective view of an assembled lid according to one embodiment of the present invention.

FIG. 13 shows a perspective view in which the base support is attached to the base, according to one embodiment of the present invention.

FIG. 14 shows a perspective view of an assembled container for encasement according to one embodiment of the present invention.

FIG. 15 shows a perspective view of a partly opened container for encasement according to one embodiment of the present invention.

FIG. 16 shows a perspective view of a fully opened container for encasement according to one embodiment of the present invention.

FIG. 17 shows an elevation view of a fully opened container for encasement according to one embodiment of the present invention.

FIG. 18 shows a perspective view illustrating the open range of a container for encasement according to one embodiment of the present invention.

### DESCRIPTION OF EMBODIMENTS

The present invention will be more specifically described below with reference to preferable embodiments. The embodiment to be described below is merely example embodiments of the present invention and do not limit the present invention.

The container for encasement 1 of the present invention includes an internal container for encasement 2 and an external container for encasement 3. The internal container for encasement 2 includes an internal container main body 2a provided with a left opening and closing case 10, a right opening and closing case 20, and a bottom 30; a lid 40; and a base 50. The base 50 includes a base support 60 for height adjustment to correspond to different heights of bottles to be encased in the container. In this embodiment, all the components of the internal container for encasement 2 and the external container for encasement 3 are made from Japanese paper and of polyethylene terephthalate, respectively. However, the materials may be changed as needed. The top, the bottom, the right, and the left directions are conveniently represented by arrows to explain the attached drawings.

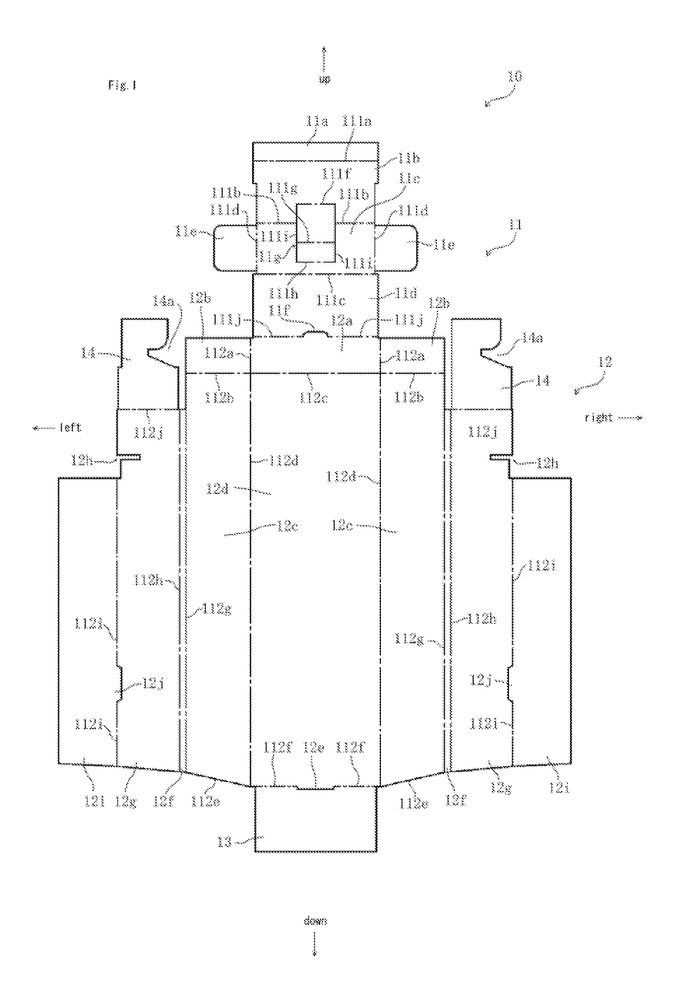

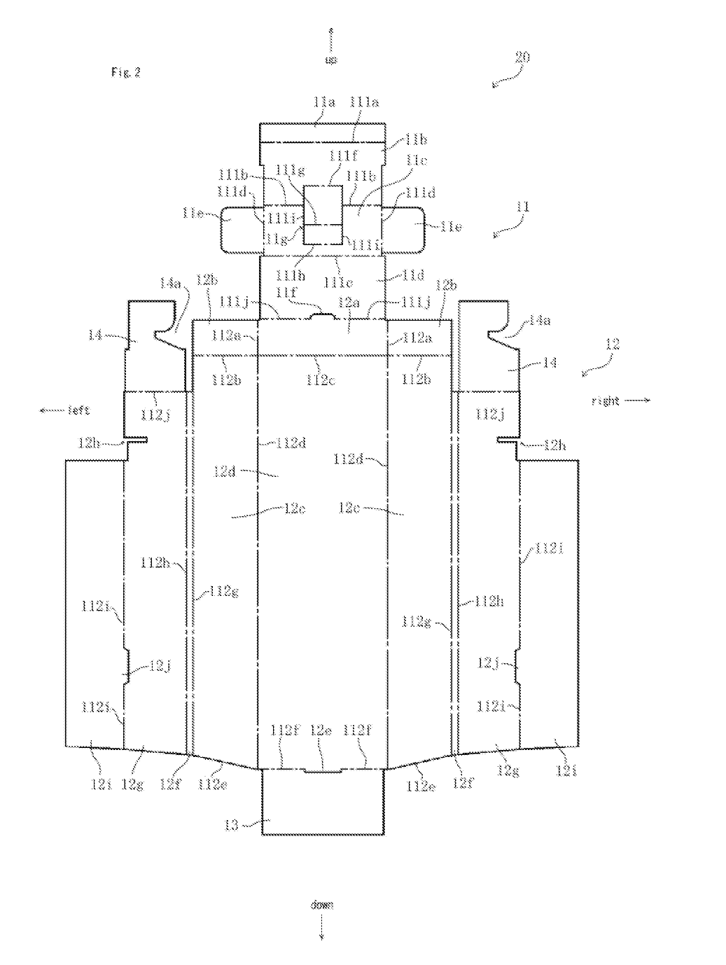

FIG. 1 shows an expansion plan of the left opening and closing case 10 according to one embodiment of the present invention. FIG. 2 shows an expansion plan of the right opening and closing case 20 according to one embodiment of the present invention. FIG. 3 shows an expansion plan of the bottom 30 according to one embodiment of the present invention. The right opening and closing case 20 shown in FIG. 2 is assembled and placed, facing the left opening and closing case 10 shown in FIG. 1. Since the right opening and closing case 20 shown in FIG. 2 has the same structure and function as the left opening and closing case 10 shown in FIG. 1, the explanation of FIG. 2 is omitted. The reference signs of the components shown in FIG. 2 are the same as those shown in FIG. 1.

As shown in FIG. 1, the left opening and closing case 10 is formed so that it can be assembled by folding one blank. The left opening and closing case 10 is formed of a bottle mouth protector 11 and a sidewall 12, and a bottom board 13 that are serially connected in order from the top. The sidewall 12 is connected with lock pieces 14, 14, one each on the left and right sides. To protect an encased bottle, the container for encasement 1 is assembled by folding the predetermined components of the left opening and closing case 10 at predetermined fold lines to form a double wall. The fold lines each represent a mountain fold line or a valley fold line. The mountain fold is to fold a blank so that the fold line comes outside. The valley fold is to fold a blank so that the fold line comes inside. In the attached drawings, the fold lines are depicted by dashed-dotted lines.

The bottle mouth protector 11 is to protect the mouth of a bottle from external impact when a bottle is encased in the container for encasement 1. The bottle mouth protector 11 is formed in the upper part of the left opening and closing case 10. The sidewall 12 is to protect the base of a bottle from external impact when a bottle is encased in the container for encasement 1. The sidewall 12 is connected with the lower side of the bottle mouth protector 11. The bottom board 13 connected with the lower side of the sidewall 12 to connect with the bottom 30. As described above, the mouth and the base of an encased bottle are protected by the left opening and closing case 10 although the bottom is protected by the base 50 and the base support 60 that will be described later.

The bottle mouth protector 11 has a rectangular engaging piece 11a, an inversed, approximately-U-shaped bottle mouth protection lower face 11b, an approximately-concave bottle mouth protection front face 11c, and an approximately-rectangle bottle mouth protection upper face 11d that are serially connected through the mountain fold line 111a, the valley fold line 111b, and the mountain fold line 111c, respectively, in order from the top. A cutout is formed in a part of the right and the left sides of the bottle mouth protection lower face 11b. The right and the left sides of the bottle mouth protection front face 11c are each connected with insertion tongue pieces 11e, 11e through valley fold lines 111d, 111d, respectively. A convex piece 11f is formed on the lower side of the bottle mouth protection upper face 11d. Mountain fold lines 111j, 111j are each formed in the right and left of the lower side of the bottle mouth protection upper face 11d, respectively. The sidewall 12 is connected with the lower side of the bottle mouth protection upper face 11d.

The container for encasement 1 is creased along the fold lines to easily fold. For example, the long fold line that is hardly folded is partially or completely perforated as needed so that it is easily folded.

The vertical direction and the horizontal direction in the attached drawings are defined herein as the “length” direction and the “width direction” direction, respectively. The engaging piece 11a and the upper part of the bottle mouth protection lower face 11b and the bottle mouth protection upper face 11d are formed in a same width. The bottle mouth protection lower face 11b and the bottle mouth protection upper face 11d are formed in a same length. The lower side of the bottle mouth protection lower face 11b and the bottle mouth protection front face 11c is formed in a width less than the length of the engaging piece 11a by the thickness of the blank. “Length” will be used for the fold lines, the side, and the like regardless of the vertical and the horizontal directions.

A rectangle bottle mouth engaging part 11g is formed in the region that extends over the bottle mouth protection lower face 11b and the bottle mouth protection front face 11c. Valley fold lines 111f and 111h are formed in the top and the bottom sides of the bottle mouth engaging part 11g, respectively. A mountain fold line 111g is formed in the approximate center. Cuts 111i, 111i are each formed in the right and the left sides, respectively. In this bottle mouth engaging part 11g, a hollow that is capable to engage with the mouth of an encased bottle is formed of the valley fold lines 111f and 111h, the mountain fold line 111g, and the cuts 111i, 111i when the left opening and closing case 10 is assembled, so that the mouth of the bottle can be protected.

The bottle mouth protector 11 forms a box with a hallow (bottle mouth engaging part 11g) when the left opening and closing case 10 is assembled. The bottle mouth protection upper face 11d forms the upper face of this box. The bottle mouth protection lower face 11b forms the lower face. The bottle mouth protection front face 11c forms the front face. The insertion tongue pieces 11e, 11e form the side faces. The back face of the box is formed of the top front inside wall 12a and the top exterior inside walls 12b, 12b that are included in the sidewall 12.

The sidewall 12 forms three sidewalls of the right, the left, and the back faces when the left opening and closing case 10 is assembled. Each sidewall is a double wall with an inside wall and an outside wall. The approximately rectangle top front inside wall 12a is connected with the lower side of the bottle mouth protection upper face 11d of the bottle mouth protector 11 through the right and the left mountain fold lines 111j, 111j. The rectangular top exterior inside walls 12b, 12b are each connected with the right and the left of the top front inside wall 12a through valley fold lines 112a, 112a, respectively. A convex cut is provided between the right and the left mountain fold lines 111j, 111j, projecting to the bottle mouth protection upper face 11d, to form the convex piece 11f. The term “outside” herein collectively includes “left side” and “right side.”

The lower sides of the right and the left top exterior inside walls 12b, 12b and the top front inside wall 12a are connected with approximately rectangle exterior outside walls 12c, 12c and a front outside wall 12d through the valley fold lines 112b, 112b, and 112c, respectively. The bottom edges 112e, 112e of the exterior outside walls 12c, 12c are formed to decline from the outside to the inside. The exterior outside walls 12c, 12c are each connected with the front outside wall 12d through valley fold lines 112d, 112d, respectively. The lengths of the exterior outside walls 12c, 12c and the front outside wall 12d are set based on the height of a bottle or the like to be encased. The widths of the exterior outside walls 12c, 12c and the front outside wall 12d are set based on the diameter of the base of a bottle or the like to be encased. Since the left opening and closing case 10 and the right opening and closing case 20 form a pair of opening and closing cases, the width of each exterior outside wall 12c and 12c only has to be about a half of that of the front outside wall 12d. The exterior outside walls 12c, 12c are the same in width.

Rectangular insertion space-forming walls 12f, 12f are each formed in the right and the left of the exterior outside wall 12c, 12c through a valley fold line 112g, 112g, respectively. The top of each insertion space-forming wall 12f, 12f is formed below the tops of the top exterior inside walls 12b, 12b by twice the length of each top exterior inside wall 12b, 12b. Accordingly, when the left opening and closing case 10 is assembled, the top exterior inside walls 12b, 12b and the top front inside wall 12a are folded along the valley fold lines 112b, 112c, 112b, respectively, to bring the tops of the top exterior inside walls 12b, 12b to contact with the tops of the respective insertion space-forming walls 12f, 12f The insertion space-forming walls 12f, 12f are formed in the approximately same width as the thickness of the blank to let in the right and the left open angle limitation pieces 33 and 34 of the bottom 30 that will be described later.

Approximately rectangle exterior inside walls 12g, 12g are each connected with the right and the left sides of the insertion space-forming wall 12f, 12f through a valley fold line 112h, 112h, respectively. Cutouts 12h, 12h are each formed in the upper parts of respective exterior insides wall 12g, 12g. The cutouts 12h, 12h are each formed to engage the right and the left edges of the engaging piece 11a of the bottle mouth protector 11 with the right and the left edges of the bottle mouth protection lower face 11b, respectively, when the left opening and closing case 10 is assembled. Furthermore, the exterior outside walls 12c, 12c each form a double outside wall, and the exterior inside walls 12g, 12g each form a double inside wall.

Approximately rectangle front inside walls 12i, 12i are each connected with the right side of the right exterior inside wall 12g and the left side of the left exterior inside wall 12g through each two mountain fold lines 112i, 112i and 112i, 112i, respectively. The width of the front inside walls 12i, 12i are set to a half of that of the front outside wall 12d. Accordingly, when the left opening and closing case 10 is assembled, the front outside wall 12d form a double outside wall, and the front inside walls 12i, 12i each form a double inside wall.

A convex cut is provided between the left mountain fold lines 112i, 112i, projecting to the left exterior inside wall 12g, to form a convex piece 12j. This convex piece 12j is formed in an approximately same width as that of the insertion space-forming wall 12f. Accordingly, the edge of the convex piece 12j is in contact with the exterior outside wall 12c (the inside face of the exterior outside wall 12c) when the left opening and closing case 10 is assembled by folding along predetermined fold lines, so that the insertion space 12k in which the left open angle limitation piece 33 of the bottom 30 that will be described later is inserted does not collapse. In the same way as the left, a convex cut is provided between the right mountain fold lines 112i, 112i, projecting to the right exterior inside wall 12g, to form a convex piece 12j. This convex piece 12j is formed in an approximately same width as that of the insertion space-forming wall 12f. Accordingly, the edge of the convex piece 12j is in contact with the exterior outside wall 12c (the inside face of the exterior outside wall 12c) when the left opening and closing case 10 is folded along predetermined fold lines and assembled, so that the insertion space 12k in which the right open angle limitation piece 34 of the bottom 30 that will be described later is inserted does not collapse.

The upper side of each exterior inside wall 12g, 12g is connected with a lock piece 14, 14 through a mountain fold line 112j, 112j. Lock cutouts 14a, 14a are each formed in lock pieces 14, 14, respectively. Accordingly, the lock cutouts 14a, 14a are engaged with each other to lock the lock pieces 14, 14 when the left opening and closing case 10 is assembled, so that the upper part of the left opening and closing case 10 can be strengthened.

The approximately rectangle bottom board 13 is formed below the front outside wall 12d through valley fold lines 112f, 112f. A convex cut is provided between the valley fold lines 112f, 112f, projecting to the bottom board b13, to form a convex piece 12e.

FIG. 2 shows an expansion plan of the right opening and closing case 20 according to one embodiment of the present invention. As described above, there is an arrangement relationship between the left opening and closing case 10 shown in FIG. 1 and the right opening and closing case 20 shown in FIG. 2 that face each other. Since the components and the functions are the same, the description of FIG. 2 is omitted. The same reference signs of the components of the left opening and closing case 10 are assigned to those of the right opening and closing case 20. In the description of FIG. 1, the left opening and closing case 10 only has to be deemed to be replaced with the right opening and closing case 20.

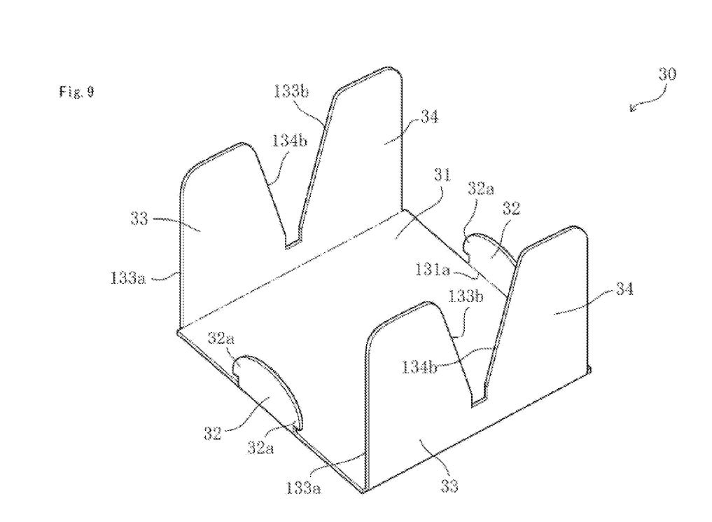

FIG. 3 shows an expansion plan of the bottom 30 according to one embodiment of the present invention. An approximately square bottom board 31 is formed in the center of the bottom 30. The length of each side of the bottom board 31 is approximately twice that of the above-mentioned bottom board 13. The respective centers of the right and the left sides of the bottom board 31 are each connected with bottom board insertion lock pieces 32, 32 through valley fold lines 131a, 131a, respectively. The left bottom board insertion lock piece 32 is formed in the shape of a tongue piece provided with fingernails 32a, 32a that each project to the upper and the lower edges, respectively. When assembled, the left opening and closing case 10 is folded along the valley fold lines 112f, 112f, and the left bottom board insertion lock piece 32 is inserted in one insertion hole 13a (refer to FIG. 8) formed between the bottom board 13 and the convex piece 12e. The valley fold line 131a is formed in a length that is approximately the same as the width of the convex piece 12e. In other words, the bottom board insertion lock piece 32 is longer than the insertion hole 13a by the heights of the fingernails 32a, 32a. The fingernails 32a, 32a are forced to be inserted when the bottom board insertion lock piece 32 is inserted in the insertion hole 13a, so that the inserted fingernails 32a, 32a are locked in the insertion hole 13a. In the same way as the left, for the right bottom board insertion lock piece 32, the fingernails 32a, 32a of the other bottom board insertion lock piece 32 can be locked in the other insertion hole 13a formed between the bottom board 13 and the convex piece 12e when the right opening and closing case 20 is assembled. As the result, the bottom board 30 can close the bottom of each of the right and the left opening and closing cases 10, 20.

The lower side of the bottom board 31 is connected with a left open angle limitation piece 33 and a right open angle limitation piece 34 in the right and the left, respectively, through a valley fold line 131b. The left open angle limitation piece 33 is an approximately trapezoidal flap, in which the left side 133a stands vertically, the right side 133b inclines, and the lower bottom is shorter than the upper bottom. The right open angle limitation piece 34 is an approximately trapezoidal flap, in which the left side 134b inclines, the right side 134a stands vertically, and the lower bottom is shorter than the upper bottom. In other words, the right open angle limitation piece 34 has the shape of the left open angle limitation piece 33 that is mirror-reversed around the centerline (not shown in the attached drawings) in the vertical direction of the bottom 30. The left open angle limitation piece 33 and the right open angle limitation piece 34 are connected with each other in their respective upper parts. The components with the reference signs 33 and 34 are named as “left open angle limitation piece” and “right open angle limitation piece,” respectively, but may be named as “left rotation amount limitation piece” and “right rotation amount limitation piece,” “left position limitation piece” and “right position amount limitation piece,” or “left distance limitation piece” and “right distance limitation piece,”

The left open angle limitation piece 33 and the right open angle limitation piece 34 on the upper side of the bottom board 31 have the shape of the left open angle limitation piece 33 and the right open angle limitation piece 34, respectively, on the lower side of the bottom board 31 that are mirror-reversed around the centerline in the horizontal direction of the bottom 30. Since the left open angle limitation piece 33 and the right open angle limitation piece 34 on the upper side have the same configuration as those on the lower side, the explanation is omitted.

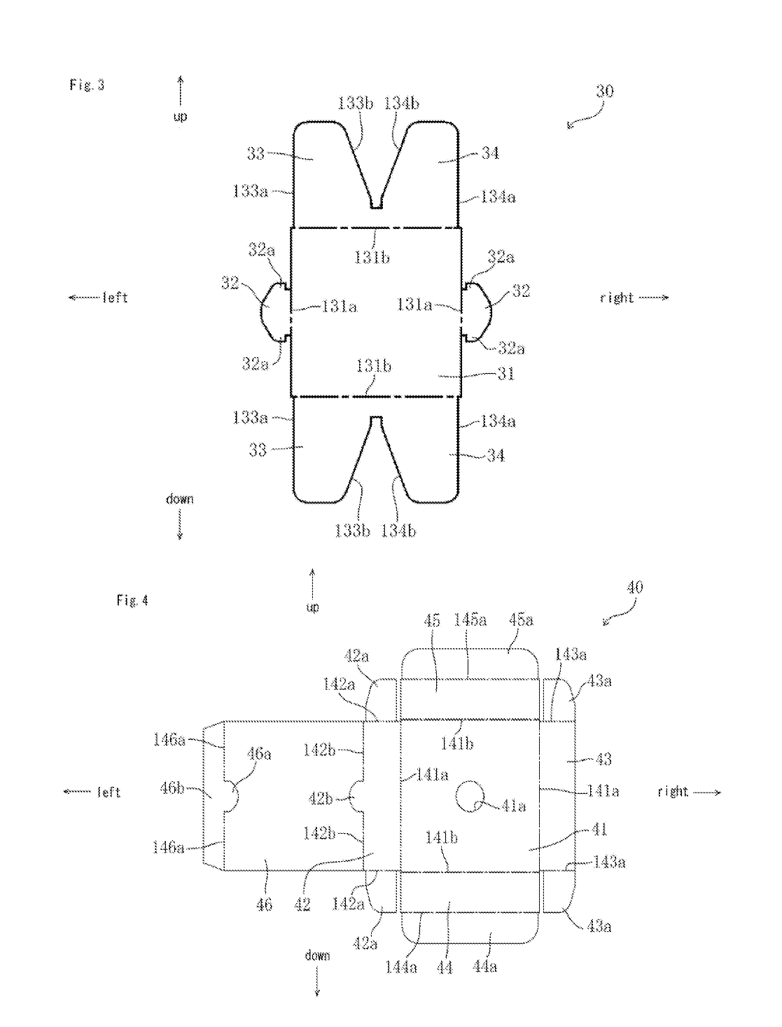

FIG. 4 shows an expansion plan of the lid 40 of an internal container for encasement 2 according to one embodiment of the present invention. The lid 40 has an approximately square upper face 41 in the center in which a circular opening 41a opens. The upper face 41 is connected with a left, a right, a front, and a back faces 42, 43, 44, and 45 through mountain fold lines 141a, 141a and 141b, 141b that are provided along the right, the left, the upper, and the lower sides of the upper face 41, respectively. The opening 41a only has to have an internal diameter enough to let in a finger of a person's. The upper and the lower sides of the left face 42 are each connected with left face flaps 42a, 42a through mountain fold lines 142a, 142a. The upper and the lower sides of the right face 43 are each connected with right face flaps 43a, 43a through mountain fold lines 143a, 143a, respectively. The lower side of the front face 44 is connected with a front face insertion piece 44a through a mountain fold line 144a. The upper side of the back face 45 is connected with a back face insertion piece 45a through a mountain fold line 145a.

The left side of the left face 42 is connected with a lower face 46 through mountain fold lines 142a, 142a. A tongue-shaped lock piece 42b is formed between the mountain fold lines 142b, 142b, projecting to the lower face 46. The left side of the lower face 46 is connected with a lower face insertion piece 46b through mountain fold lines 146a, 146a. A tongue-shaped lock piece 46a is formed between the mountain fold lines 146a, 146a, projecting to the lower face 46. The lock pieces 42b and 46a may have a same shaped tongue pieces.

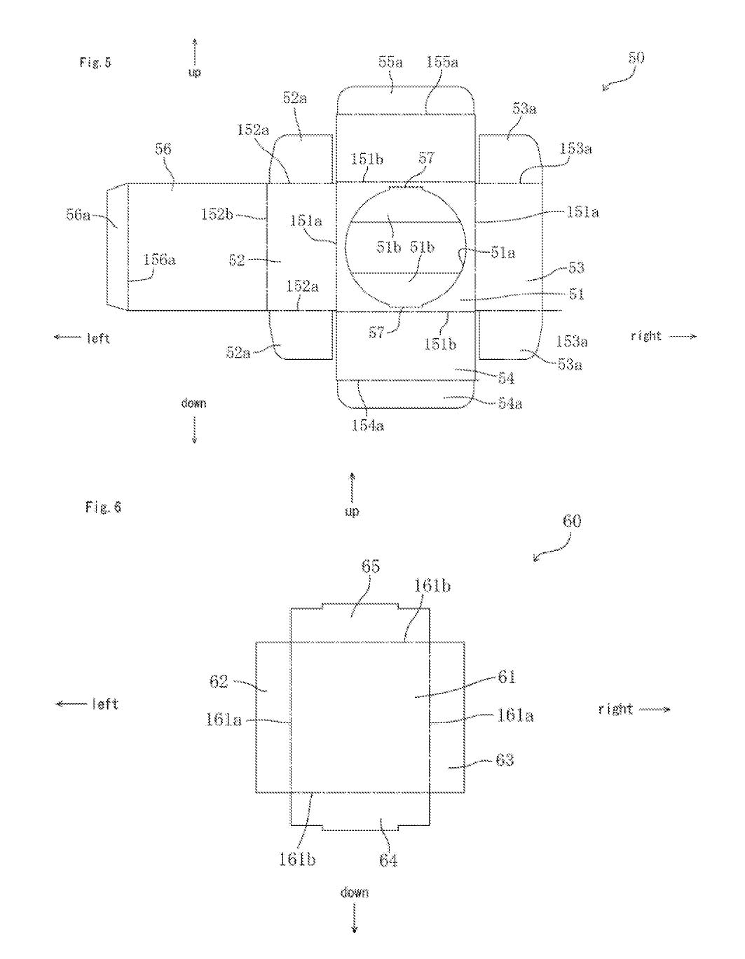

FIG. 5 shows an expansion plan of the base 50 of an internal container for encasement 2 according to one embodiment of the present invention. The base 50 has a very similar structure as the lid 40. The base 50 has an approximately square upper face 51 in which an approximately circular opening 51a opens. The upper face 51 is connected with a left, a right, a front, and a back faces 52, 53, 54, and 55 through mountain fold lines 151a, 151a and 151b, 151b that are provided on the right, the left, the upper, and the lower sides of the upper face 51, respectively. In the hinges 57, 57 that are each on the top and the bottom of the opening 51a, respectively, partially circular flaps 51b, 51b with a chord length less than the internal diameter of the opening 51a are each formed. The internal diameter of the opening 51a is formed based on the diameter of the base of an encased bottle or the like. The base support 60 to be described later is attached to the bottom of the base 50 according to this embodiment. The base 50 may not be provided with a base support 60 as needed. In this case, the flaps 51b, 51b are formed in a hemicycle, and the internal diameter of the opening 51a is increased according to the diameter of the base of an encased bottle. Preparing two or more bases 50 that have an opening 51a with a different size and two or more base supports 60 that have side faces of a different height enables one container for encasement 1 to deal with two or more kinds of bottles with a different height and a different diameter of the base.

The upper and the lower sides of the left face 52 are connected with a left face flap 52a, 52a through a mountain fold line 152a, 152a. The upper and the lower sides of the right face 53 are connected with a right face flap 53a, 53a through a mountain fold line 153a, 153a. The lower side of the front face 54 is connected with a front face insertion piece 54a through a mountain fold line 154a. The upper side of the back face 55 is connected with a back face insertion piece 55a through a mountain fold line 155a. The left side of the left face 52 is connected with a lower face 56 through a mountain fold line 152a. The left side of the back face 56 is connected with a back face insertion piece 56a through a mountain fold line 156a. The lid 40 forms a box that has an opening when assembled.

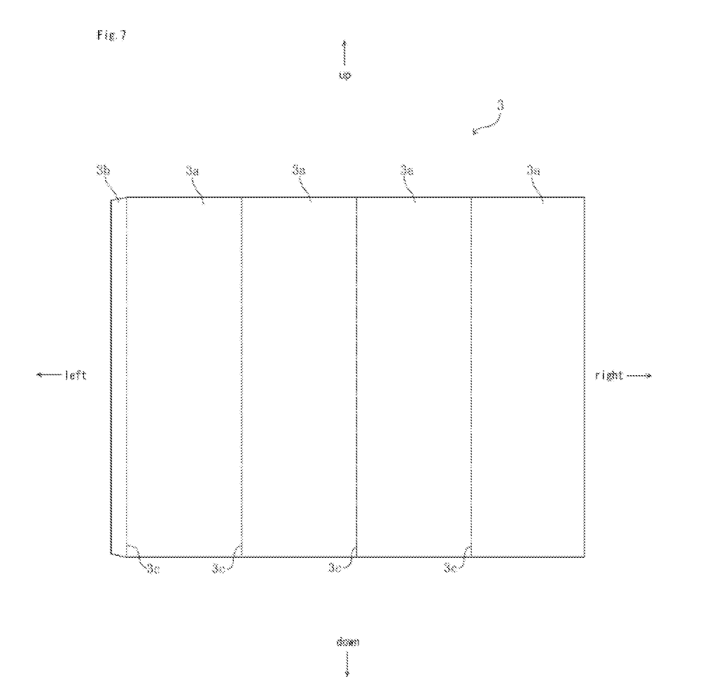

FIG. 6 shows an expansion plan of the base support 60 of an internal container for encasement 2 according to one embodiment of the present invention

The base support 60 has an approximately square upper face 61. The upper face 61 is connected with a left, a right, a front, and a back faces 62, 63, 64, and 65 through mountain fold lines 161a, 161a and 161b, 161b that are provided on the right, the left, the upper, and the lower sides of the upper face 61, respectively. As described above, the base support 60 is attached to the base 50 and capable to adjust its height according to the height of an encased bottle.

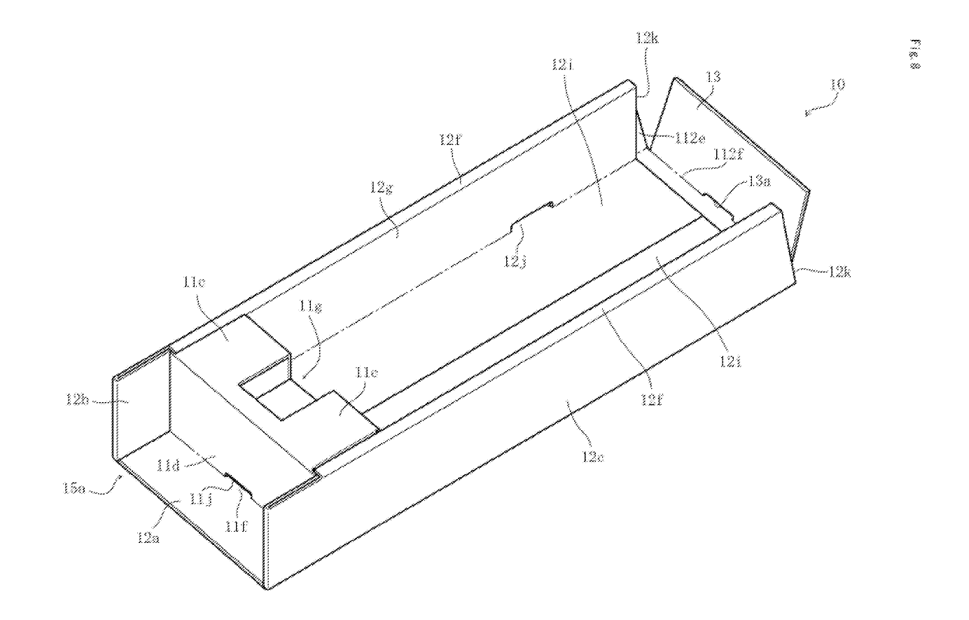

FIG. 7 shows an expansion plan of an external container for encasement 3 according to one embodiment of the present invention. The external container for encasement 3 is unfolded in one approximately rectangular shape. In the external container for encasement 3, an overlap width 3b is formed at the left edge. The overlap width 3b and four sidewalls 3a with a same width are serially connected in the right direction from the overlap width part 3b through each of four valley fold lines 3c. When the external container for encasement 3 is assembled, the overlap width 3b is glued with the sidewall 3a at the edge of the right side to form a square hollow. After assembled, the external container for encasement 3 covers the internal container for encasement 2 for use.

Since the external container for encasement 3 is used as a candle sleeve, the sidewalls have a predetermined translucent pattern (now shown in the attached drawings). When the external container for encasement 3 is used as a candle sleeve, a candle is set in the external container for encasement 3. In this case, any one of the lid 40, the base 50, the base support 60, and the like may be used as a candle stand, or a special candle stand may be used. Changing the pattern in the sidewalls according to surroundings effectively creates various atmospheres. According to the present invention, the light radiated from the flame of a candle set in the candle sleeve projects the translucent pattern formed on the side faces of the candle sleeve to the surroundings, so that an atmosphere at the user's desire can be created. For example, if the translucent pattern is formed to tell the traditional culture of Japan, its atmosphere can be created.

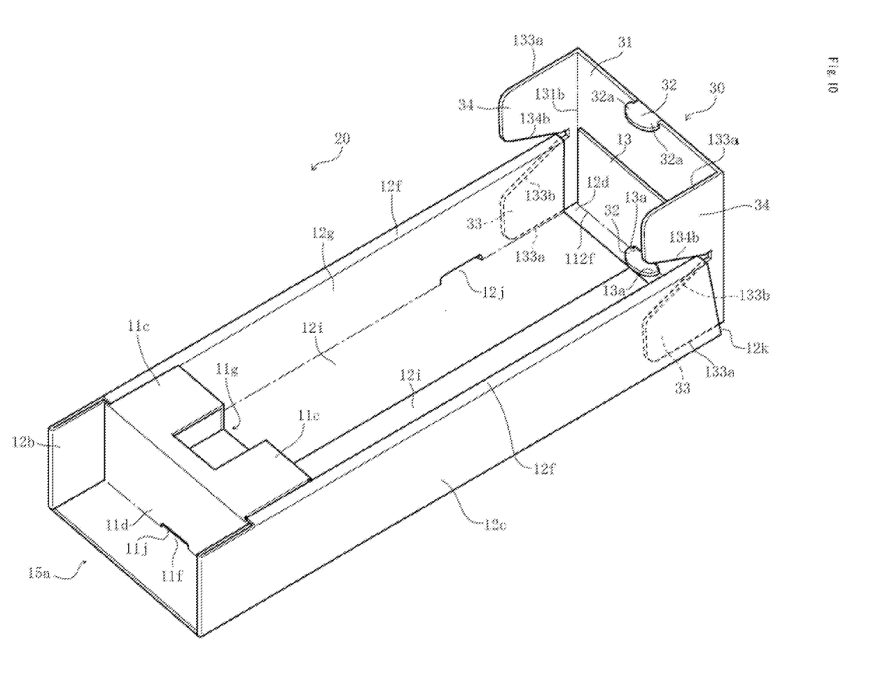

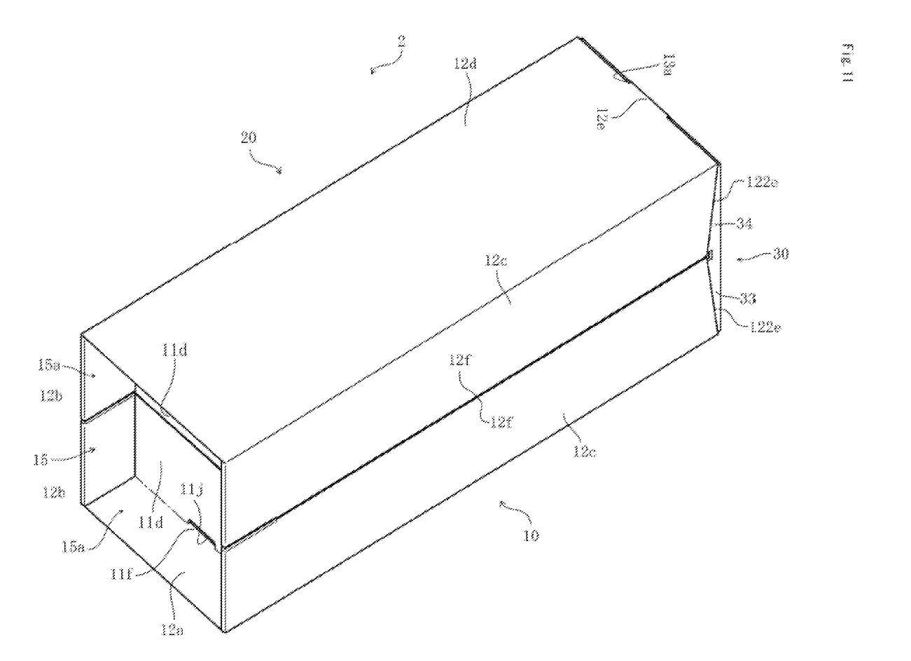

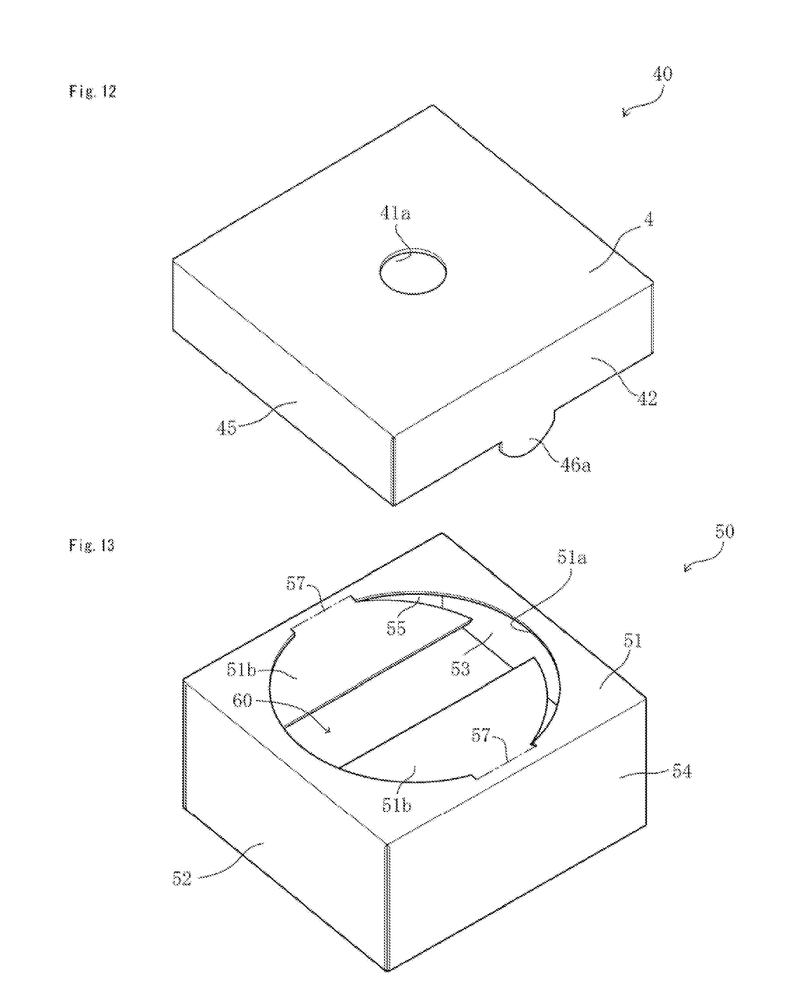

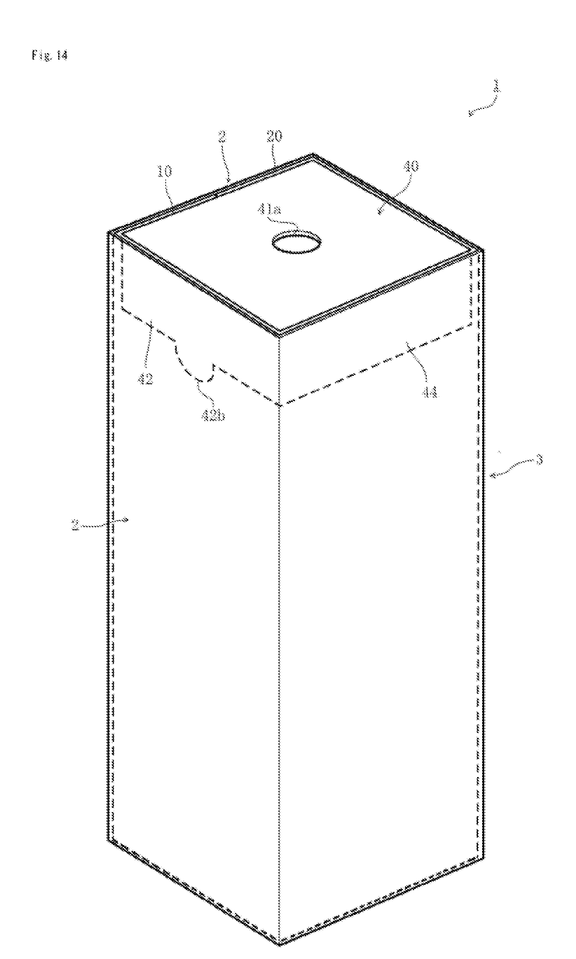

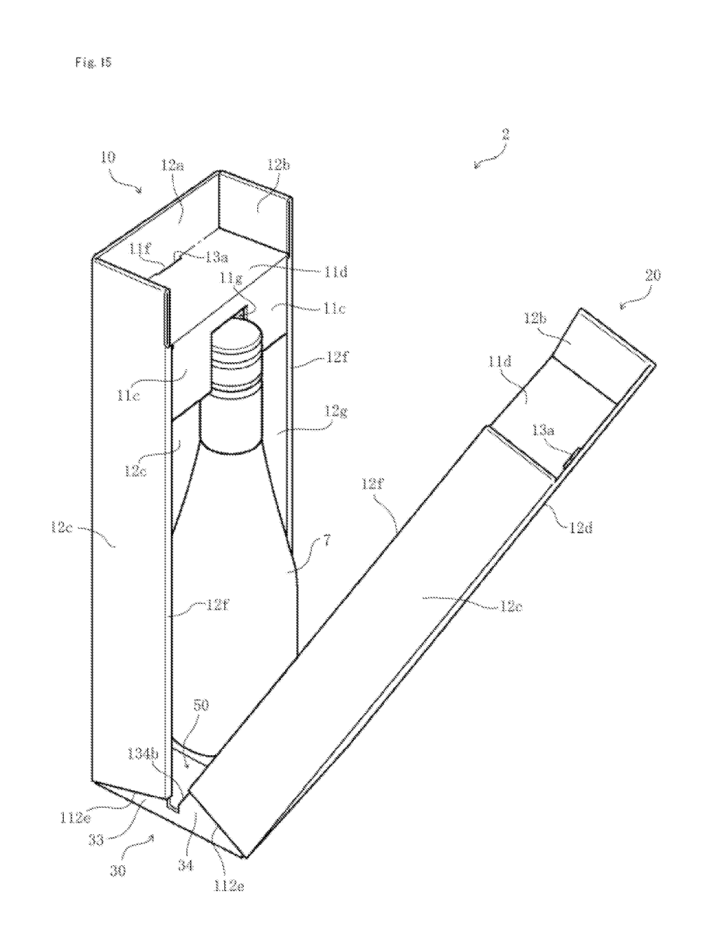

How to assemble the container for encasement 1 according to one embodiment of the present invention will be described below with reference to FIGS. 8 to 14. FIG. 8 shows a perspective view of an assembled left opening and closing case 10 according to one embodiment of the present invention. FIG. 9 shows a perspective view of an assembled bottom 30 according to one embodiment of the present invention. FIG. 10 shows a perspective view in which the bottom 30 is attached to the left opening and closing case 10, according to one embodiment of the present invention. FIG. 11 shows a perspective view in which the bottom 30 is attached to the left opening and closing case 10 and the right opening and closing case 20, according to one embodiment of the present invention. Specifically, FIG. 11 illustrates an assembled internal container main body 2a. FIG. 12 shows a perspective view of an assembled lid 40 according to one embodiment of the present invention. FIG. 13 shows a perspective view in which the base support 60 is attached to the base 50, according to one embodiment of the present invention. FIG. 14 shows a perspective view of an assembled container for encasement 1 according to one embodiment of the present invention.

As shown in FIG. 8, the left opening and closing case 10 that has been by predetermined fold lines and assembled forms a box with a double wall that opens to let in and out a bottle. The bottle mouth protection upper face 11d, the top front inside wall 12a, the top exterior inside walls 12b, 12b form an fixing concave 15a to fix a half of the lid 40. The lock piece 42b of the assembled lid 40 is inserted in the insertion hole 11j to lock a half of the lid 40 in the left opening and closing case 10. The bottle mouth engaging part 11g is formed to engage and fix the mouth of an encased bottle so that the mouth of an encased bottle is protected from external impact. The exterior outside walls 12c, 12c and the front outside wall 12d form a half of the outside walls of the internal container for encasement 2. The exterior outside wall 12c, the insertion space-forming wall 12f, the exterior inside wall 12g, and the convex piece 12j form an insertion space 12k. The right opening and closing case 20 has the structure paired with that of the left opening and closing case 10 in the internal container main body 2a and assembled in the same way as the left opening and closing case 10. Thus, the explanation is omitted.

As shown in FIG. 9, the bottom 30 is folded in predetermined fold lines to stand the pieces in the same direction (the upper direction in FIG. 9) and attached to the right and the left opening and closing cases 10 and 20 to form the bottom of the internal container main body 2a. The bottom 30 is a means to limit the open range of the right and the left opening and closing cases 10 and 20 when they are opened. The details will be described later.

As shown in FIG. 10, the left open angle limitation pieces 33, 33 of the bottom 30 that have been folded in predetermined fold lines and assembled are each inserted in the insertion spaces 12k, 12k of the left opening and closing case 10, respectively. At this time, the bottom board insertion lock piece 32 of the bottom 30 is inserted in the insertion hole 13a to lock a half of the bottom 30 in the left opening and closing case 10.

As shown in FIG. 11, the right open angle limitation pieces 34, 34 of the bottom 30 that have been folded in predetermined fold lines and assembled are each inserted in the insertion spaces 12k, 12k of the right opening and closing case 20, respectively. At this time, the bottom board insertion lock piece 32 of the bottom 30 is inserted in the insertion hole 13a to lock the other half of the bottom 30 in the right opening and closing case 20. The insertion space-forming walls 12f, 12f are each formed to be contact with the left opening and closing case 10 and the right opening and closing case 20, respectively. This is the situation when the right and the left opening and closing cases 10 and 20 are closed. This situation may represent that the internal container main body 2a, the internal container for encasement 2, and the container for encasement 1 are also closed.

As shown in FIG. 12, the lid 40 is folded along predetermined fold lines and assembled to form to a box. The lid 40 can be easily attached to and detached from the internal container main body 2a by putting a finger of user's in the opening 41a. When the lid 40 is engaged with the fixing concave 15 formed of the fixing concave 15a, 15a of each of the right and the left opening and closing cases 10 and 20 after an bottle is encased, the lock pieces 42b and 46a are each inserted and locked in the insertion hole 11j formed of the bottle mouth protection upper face 11d and the convex piece 11f of each of the right and the left opening and closing case 10 and 20, respectively. Accordingly, the right and the left opening and closing cases 10 and 20 can be kept closed.

As shown in FIG. 13, the base 50 is folded along predetermined fold lines and assembled to form a box in which an approximately circular opening 51a opens. The internal diameter of the opening 51a of the base 50 is formed based on the diameter of the base of an encased bottle or the like. The flaps 51b, 51b are rotatable through the respective hinges 57, 57. The base 50 is fixed in the bottom of the internal container main body 2a. In addition, the bottom of an encased bottle is inserted to the opening 51a of the base 50. In this embodiment, the base support 60 that has been folded along predetermined fold lines and assembled is attached to the lower face 56 of the base 50 to correspond to the height of a bottle. However, the base support 60 may be removed depending on the height of a bottle. According to this structure as described above, the bottom of an encased bottle is protected from external impact.

The base 50 and optionally the base support 60 are provided in the bottom of the internal container main body 2a that is formed of the right and the left opening and closing cases 10 and 20 and the bottom 30. Then, the external container for encasement 3 covers the internal container for encasement 2 that is formed with the lid 40 provided in the top to form the container for encasement 1 as shown in FIG. 14. Therefore, the vertically long container for encasement 1 according to this embodiment can easily let a bottle in or out, or in and out in the standing position. The container for encasement 1 according to this embodiment that is containing a bottle of sake, wine, or the like can be wrapped with a cloth wrapper and used for a gift. In this case, the pattern of the side faces of the external container for encasement 3 used as a candle sleeve should be the same as that of a wrapper.

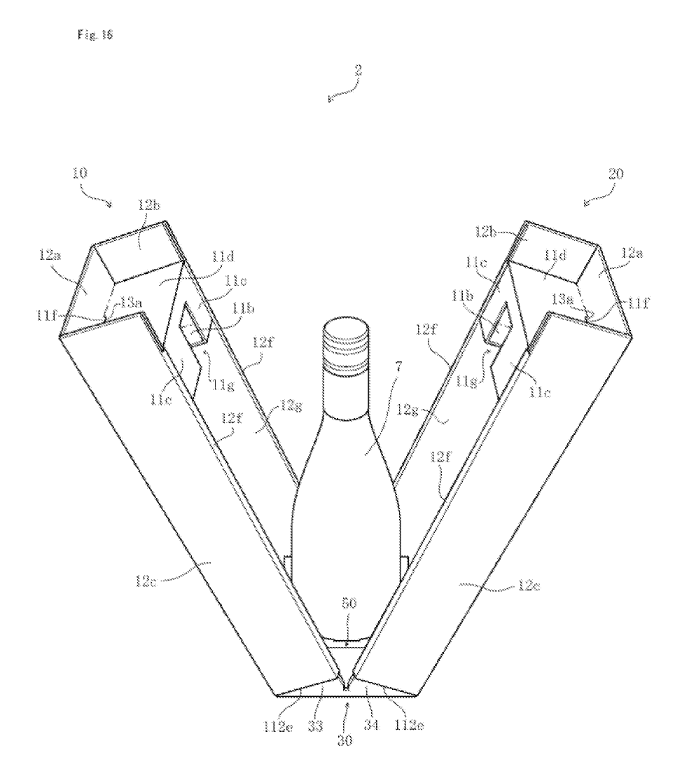

FIGS. 15 to 17 show that the right and the left opening and closing cases 10 and 20 are being opened to take out a bottle 7 encased in the container for encasement 1. FIG. 15 shows that the container for encasement 1 is half-opened. In this situation, the external container for encasement 3 and the lid 40 are removed from the container for encasement 1, and the right opening and closing case 20 is fully opened while a bottle 7 encased in the left opening and closing case 10. The left opening and closing case 10 to which the bottom 30 is attached stands approximately upright. The right opening and closing case 20 is inclined at a predetermined angle.

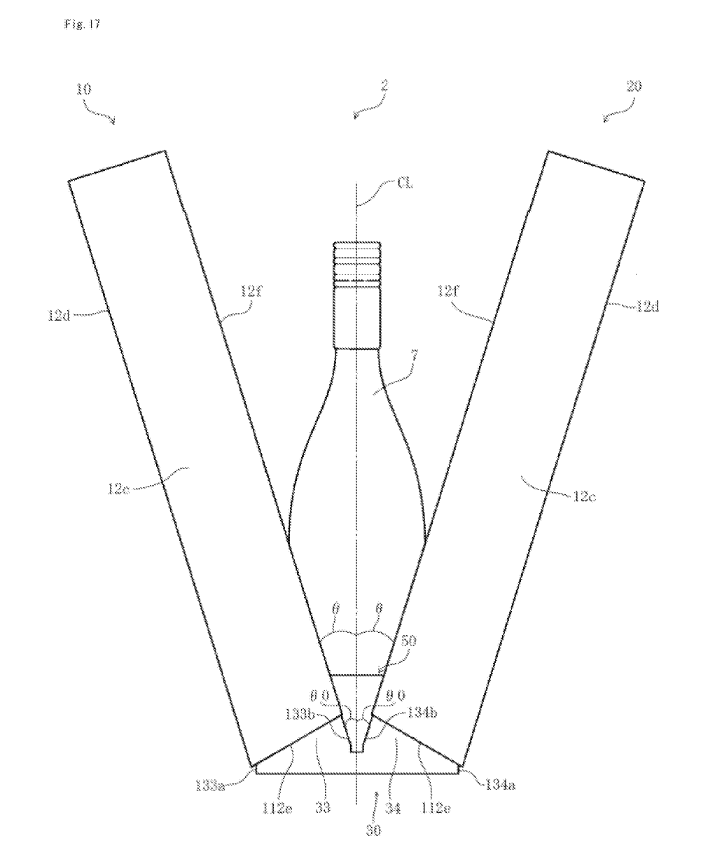

FIG. 16 shows that the container for encasement 1 is fully opened. In this situation, the left opening and closing case 10 is fully opened as well as the right opening and closing case 20. In the same way as the right opening and closing case 20, the left opening and closing case 10 is opened and inclined at a predetermined angle. A bottle 7 can be inserted in and withdrawn from the container for encasement 1 usually in this fully opened situation. While the container for encasement 1 is fully opened, the angle where the right and the left opening and closing cases 10 and 20 open, which is the open angle, is limited. Therefore, an encased bottle 7 can be easily withdrawn from the container 1 for encasement in their standing positions. Furthermore, a bottle 7 can be easily inserted in the container 1 for the encasement in their standing positions.

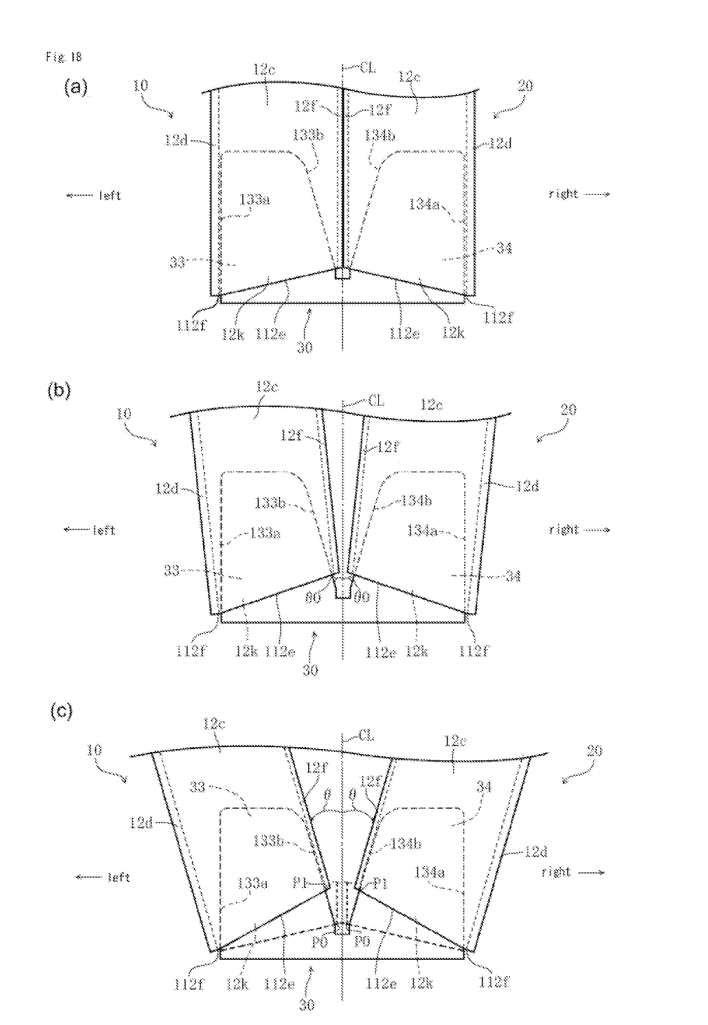

FIG. 17 shows an elevation view of a fully opened container for encasement 1. When the container for encasement 1 is closed, in other words, when the right and the left opening and closing cases 10 and 20 are closed, the insertion space-forming walls 12f, 12f are in close contact with each other in the vertical direction and approximately fall in the centerline CL in the vertical direction of the encased bottle 7. The angle between the left opening and closing case 10 (insertion space-forming wall 12f) and the centerline CL is designated as the open angle θ when the left opening and closing case 10 is opened. In this case, the open angle θ with respect to the fully opened left opening and closing case 10 is set to be approximately equal to the inclination angle θ0 between the right side 133b of the left open angle limitation piece 33 of the bottom 30 and the centerline CL. In the same way as the left, the open angle θ with respect to the fully opened right opening and closing case 20 (insertion space-forming wall 12f) is set to be approximately equal to the inclination angle θ0 between the left side 134b of the right open angle limitation piece 34 of the bottom 30 and the centerline CL. The right and the left opening and closing cases 10 and 20 (insertion space-forming walls 12f) are prevented from opening at more than the open angle θ.

FIG. 18 shows the reason why the open angle is limited. FIG. 18(a) shows that the container for encasement 1 is (the right and the left opening and closing cases 10 and 20 are) closed. FIG. 18(b) shows that the container for encasement 1 is opening. FIG. 18(c) shows that the container for encasement 1 is fully opened.

While the container for encasement 1 is closed, the left open angle limitation piece 33 is inserted in the insertion space 12k formed of the front outside wall 12d, the exterior outside wall 12c, and the exterior inside wall 12g of the left opening and closing case 10. On the other hand, the right open angle limitation piece 34 is inserted in the insertion space 12k formed of the front outside wall 12d, the exterior outside wall 12c, the insertion space-forming wall 12f, and the exterior inside wall 12g of the right opening and closing case 20. While the left opening and closing case 10 is closed, the left side 133a of the left open angle limitation piece 33 and the front outside wall 12d (the inside face of the front outside wall 12d) are preferably in close contact with each other, but there may be a small space between them.

In this situation, the right side 133b of the left open angle limitation piece 33 is further away from the insertion space-forming wall 12f (the inside face of the insertion space-forming wall 12f) as it goes from the bottom to the top. In the same way as the left, while the right opening and closing case 20 is closed, the left side 134a of the right open angle limitation piece 34 and the front outside wall 12d (the inside face of the front outside wall 12d) are preferably in close contact with each other, but there may be a small space between them. In this situation, the left side 134b of the right open angle limitation piece 34 is further away from the insertion space-forming wall 12f (more specifically, the inside face of the insertion space-forming wall 12f) as it goes from the bottom to the top.

When the right and the left opening and closing cases 10 and 20 are opened from this closed situation, the left opening and closing case 10 is first rotated around the valley fold line 112f as the axis to the left as shown in FIG. 18(b). Then, the front outside wall 12d of the left opening and closing case 10 is gradually separated from the left side 133a of the closely contacted left open angle limitation piece 33. However, the separated upper part of the insertion space-forming wall 12f gradually approaches the right side 133b of the left open angle limitation piece 33. When the open angle θ with respect to the left opening and closing case 10 (insertion space-forming wall 12f) is approximately equal to the inclination angle θ0 between the right side 133b of the left open angle limitation piece 33 and the centerline CL as shown in FIG. 18(c), the insertion space-forming wall 12f is in contact with the right side 133b, and the rotation is stopped. Finally, the left opening and closing case 10 is prevented from opening at more than the open angle θ when stopped to rotate.

In the same way as the left, the right opening and closing case 20 is rotated around the valley fold line 112f as the axis to the right as shown in FIG. 18(b). Then, the front outside wall 12d of the right opening and closing case 20 is gradually separated from the right side 134a of the closely contacted right open angle limitation piece 34. However, the separated upper part of the insertion space-forming wall 12f gradually approaches the left side 134b of the right open angle limitation piece 34. When the open angle θ with respect to the right opening and closing case 20 (insertion space-forming wall 12f) is approximately equal to the inclination angle θ0 between the left side 134b of the right open angle limitation piece 34 and the centerline CL as shown in FIG. 18(c), the insertion space-forming wall 12f is in contact with the left side 134b, and the rotation is stopped. Finally, the right opening and closing case 20 is prevented from opening at more than the open angle θ when stopped to rotate.

The open angles of the right and the left opening and closing cases 10 and 20 (insertion space-forming walls 12f, 12f) that are described above can be deemed to be replaced with the rotation amounts (or rotating amounts) of the right opening and closing cases 10 and 20 (insertion space-forming walls 12f, 12f) that rotate around the centerline CL.

The range where the container for encasement 1 opens is explained above in terms of angle but can also be explained as described below in terms of position. When the left opening and closing case 10 is rotated around the valley fold line 112f as the axis to the left, and then the bottom (inside face) of the insertion space-forming wall 12f is in contact with the right side 133b at the position P1 where “the length of the bottom edge 112e of the exterior outside wall 12c” is equal to “the straight-line distance from the valley fold line 112f to the right side 133b,” and the rotation is stopped (refer to FIG. 18(c)). As the left opening and closing case 10 goes upward from the position P1 of the right side 133b, “the straight-line distance from the valley fold line 112f to the right side 133b” becomes more than “the length of the bottom edge 112e of the exterior outside wall 12c,” and in other words, the right side 133b is linearly inclined as shown in FIG. 18(c). Accordingly, the range where the insertion space-forming wall 12f is in contact with the right side 133b is longer (or wider). Finally, the left opening and closing case 10 is prevented from rotating upward from the position P1.

In the same way as the left, when the right opening and closing case 20 is rotated around the valley fold line 112f as the axis to the right, and then the bottom (inside face) of the insertion space-forming wall 12f is in contact with the left side 134b at the position P1 where “the length of the bottom edge 112e of the exterior outside wall 12c” is equal to “the straight-line distance from the valley fold line 112f to the left side 134b,” and the rotation is stopped (refer to FIG. 18(c)). As the right opening and closing case 20 goes upward from the position P1 of the left side 134b, “the straight-line distance from the valley fold line 112f to the left side 134b” becomes more than “the length of the bottom edge 112e of the exterior outside wall 12c,” and in other words, the left side 134b is linearly inclined as shown in FIG. 18(c). Accordingly, the range where the insertion space-forming wall 12f is in contact with the left side 134b is longer (or wider). Finally, the right opening and closing case 20 is prevented from rotating upward from the position P1.

It can also be expressed that if the position of the bottom (inside face) of each insertion space-forming wall 12f, 12f is designated as P0 while the right and the left opening and closing cases 10 and 20 are closed, the right and the left opening and closing cases 10 and 20 are prevented from opening more than the distance between the positions P1 and P0.

In addition, the rotation (rotating) amount and the position P1 of each of the right and the left opening and closing cases 10 and 20 (each insertion space-forming wall 12f, 12f) and the open angle θ and the distance P1-P0 between the right and the left opening and closing cases 10 and 20 (insertion space-forming walls 12f, 12f) are collectively herein referred to as the range where the right and the left opening and closing cases 10 and 20 open.

As described above, according to the present invention, the container for encasement provided with an opening and closing case is formed to prevent the opening and closing case from opening more than a predetermined range when the opening and closing case is opened to let a bottle in or out, or in and out in the standing position. Therefore, the container for encasement can easily let a bottle in or out, or in and out in the standing position.

### REFERENCE SIGNS LIST

1 container for encasement
2 internal container for encasement
2a internal container main body
3 outside container for encasement
3a sidewall
3b overlap width
3c valley fold line
10 left opening and closing case
11 bottle mouth protector
11a engaging piece
11b bottle mouth protection lower face
11c bottle mouth protection front face
11d bottle mouth protection upper face
11e insertion tongue piece
11f, 12e, 12j convex piece
11g bottle mouth engaging part
11j, 13a insertion hole
12 sidewall
12a top front inside wall
12b top exterior inside wall
12c exterior outside wall
12d front outside wall
12f insertion space-forming wall
12g exterior inside wall
12h cutout
12i front inside wall
12k insertion space
13, 31 bottom board
14 lock piece
14a lock cutout
15, 15a fixing concave
20 right opening and closing case
30 bottom
32 bottom board insertion lock piece
32a fingernail
33 left open angle limitation piece
34 right open angle limitation piece
40 lid
41, 51, 61 upper face
41a, 51a opening
42, 52, 62 left face
42a left face flap
42b, 46a lock piece
43, 53, 63 right face
43a right face flap
44, 54, 64 front face
44a front face insertion piece
45, 55, 65 back face
45a back face insertion piece
46, 56 lower face
46b lower face insertion piece
50 base
51b flap
52a left face flap
53a right face flap
54a front face insertion piece
55a back face insertion piece
56a lower face insertion piece
57 hinge
60 base support
111a,111c,111g,111j,112a,112i,112j,141a,141b,142a,142b,143a,144a,145 a,146a,151a,151b,152a,152b,153a,154a,155a,156a,161a,161b mountain fold line
111b,111d,111f,111h,112b,112c,112d,112f,112g,112h,131a,131b valley fold line
112e bottom edge
133a left side
133b right side

1. A container for encasement comprising:
an internal container for encasement; and
an external container for encasement, wherein
the internal container for encasement includes:
an opening and closing case that is capable to open and close to let an object in or out, or in and out; and
a limitation part that limits the open range of the opening and closing case when the opening and closing case opens, and
the limitation part is provided in the bottom of the internal container for encasement and includes a flap that has an inclining side and limits the open range of the opening and closing case by attaching the flap to the opening and closing case and engaging the inclining side with the opening and closing case.

2. A container for encasement comprising:
an internal container for encasement; and
an external container for encasement, wherein
the internal container for encasement includes:
an opening and closing case that is capable to open and close to let an object in or out, or in and out; and
a limitation part that limits the open range of the opening and closing case when the opening and closing case opens, and
the internal container for encasement further includes a lid on the top and a base on the bottom, the lid locks the opening and closing case to keep the opening and closing case closed, and the base is fixed in the bottom of the internal container for encasement to protect the bottom of the object.

3. The container for encasement according to claim 1, wherein the open range of the opening and closing case is an open angle of the opening and closing case.

4. The container for encasement according to claim 1, wherein the open range of the opening and closing case is an amount of rotation of the opening and closing case.

5. The container for encasement according to claim 1, wherein the open range of the opening and closing case is a position where the opening and closing case opens.

6. The container for encasement according to claim 1, wherein the open range of the opening and closing case is a distance where the opening and closing case opens.

7. The container for encasement according to claim 1, wherein the opening and closing case includes a pair of a first and a second opening and closing cases that are placed to face each other.

8. The container for encasement according to claim 1, wherein the upper part of the opening and closing case includes a top protection part that protects the top of the encased object.

9. The container for encasement according to claim 1, wherein the external container for encasement is formed as a candle sleeve.

10. (canceled)

11. (canceled)
